(19) United States
(12) Patent Application Publication
(10) Pub. No.: US 2008/0090118 A1
(43) Pub. Date: Apr. 17, 2008

(54) Catalyst for oxidizing carbon monoxide for reformer used in fuel cell, method for preparing the same, and fuel cell system comprising the same

(76) Inventors: Leonid Gorobinskiy, Suwon-si (KR); Ju-Yong Kim, Suwon-si (KR); Jin-Kwang Kim, Suwon-si (KR); Dong-Myung Suh, Suwon-si (KR); Jin-Goo Ahn, Suwon-si (KR); Dong-Uk Lee, Suwon-si (KR); Sung-Chul Lee, Suwon-si (KR); Man-Seok Han, Suwon-si (KR); Chan-Ho Lee, Suwon-si (KR); Yong-Kul Lee, Suwon-si (KR)

Correspondence Address: Robert E. Bushnell;Suite 300, 1522 K Street, N.W., Washington, DC, 20005, US

(21) Appl. No.: 11/802,719

(22) Filed: May 24, 2007

(30) Foreign Application Priority Data
Aug. 23, 2006 (KR) 10-2006-0079976

(51) Int. Cl. H01M 8/06; B01J 23/50; B01J 23/52; B01J 23/02; B01J 21/08; B01J 21/02

(52) U.S. Cl. 429/20; 502/347; 502/348; 502/243; 502/340; 429/19

(57) ABSTRACT

The carbon monoxide oxidizing catalyst for a reformer of a fuel cell system according to the present invention includes an active material including Au—Ag alloy nano-particles, and a carrier supporting the active material.

### CROSS-REFERENCE TO RELATED APPLICATION AND CLAIM OF PRIORITY

This application claims priority to and the benefit of Korean Patent Application No. 10-2006-0079976 filed in the Korean Intellectual Property Office on Aug. 23, 2006, the entire content of which is incorporated herein by reference.

### BACKGROUND OF THE INVENTION

(a) Field of the Invention

The present invention relates to a carbon monoxide oxidizing catalyst for a reformer of a fuel cell system, to a method of preparing the same, to a reformer including the same, and to a fuel cell system including the same. More particularly, the present invention relates to a carbon monoxide oxidizing catalyst having improved carbon monoxide oxidation activity and selectivity.

(b) Description of the Related Art

A fuel cell is a power generation system for producing electrical energy through an electrochemical redox reaction of an oxidant and fuel such as hydrogen, or a hydrocarbon-based material such as methanol, ethanol, natural gas, and the like. Such a fuel cell is a clean energy source that can replace fossil fuels. It includes a stack composed of unit cells and produces various ranges of power output. Since it has a four to ten times higher energy density than a small lithium battery, it has been highlighted as a small portable power source.

Representative exemplary fuel cells include a polymer electrolyte membrane fuel cell (PEMFC) and a direct oxidation fuel cell (DOFC). The direct oxidation fuel cell includes a direct methanol fuel cell that uses methanol as a fuel.

In the above-mentioned fuel cell system, a stack that generates electricity substantially includes several to scores of unit cells stacked adjacent to one another, and each unit cell is formed of a membrane-electrode assembly (MEA) and a separator (also referred to as a bipolar plate). The membrane-electrode assembly is composed of an anode (also referred to as a “fuel electrode” or an “oxidation electrode”) and a cathode (also referred to as an “air electrode” or a “reduction electrode”) that are separated by a polymer electrolyte membrane.

A fuel is supplied to the anode and adsorbed on catalysts of the anode, and the fuel is oxidized to produce protons and electrons. The electrons are transferred into the cathode via an external circuit, and the protons are transferred into the cathode through the polymer electrolyte membrane. In addition, an oxidant is supplied to the cathode, and then the oxidant, the protons, and the electrons are reacted on catalysts of the cathode to produce electricity along with water.

A fuel cell system is generally composed of a stack, a reformer, a fuel tank, and a fuel pump. The stack forms a body of the fuel cell system, and the fuel pump provides the fuel stored in the fuel tank to the reformer. The reformer reforms the fuel to generate the hydrogen gas and supplies the hydrogen gas to the stack.

A reformer of a general fuel cell system includes a reforming reaction part that generates hydrogen gas from a fuel through a catalyst reforming reaction using heat energy, and a carbon monoxide reducing part that reduces a carbon monoxide concentration in the hydrogen gas through an oxidizing reaction of the hydrogen gas with oxygen. Such a reforming reaction is performed by a reforming catalyst and therefore there is much research into a reforming catalyst being undertaken.

### SUMMARY OF THE INVENTION

One aspect of the present invention provides a carbon monoxide oxidizing catalyst for a reformer of a fuel cell system having excellent carbon monoxide oxidation activity.

Another aspect of the present invention provides a method of preparing the carbon monoxide oxidizing catalyst.

Still another aspect of the present invention provides a reformer of a fuel cell system including the carbon monoxide oxidizing catalyst.

Yet another aspect of the present invention provides a fuel cell system including the carbon monoxide oxidizing catalyst.

According to one aspect of the present invention, a carbon monoxide oxidizing catalyst for a reformer of a fuel cell system is provided, which includes an active material including an Au—Ag alloy nano-particle, and a carrier supporting the active material.

According to another aspect of the present invention, a method of preparing a carbon monoxide oxidizing catalyst for a reformer of a fuel cell system is provided, which includes preparing a precursor solution by adding Au and Ag precursors to an ionic surfactant aqueous solution, adding a reducing agent to the precursor solution, adding a carrier to the precursor solution, drying the precursor solution to obtain a dried product, and calcinating the dried product.

According to yet another aspect of the present invention, a fuel cell system is provided, which includes a reformer including a reforming reaction part that generates hydrogen gas from a fuel through a catalyst reforming reaction using heat energy, and a carbon monoxide reducing part that reduces a carbon monoxide concentration in the hydrogen gases through an oxidizing reaction of carbon monoxide with an oxidant; at least one electricity generating element for generating electrical energy by electrochemical reactions of the hydrogen gas and the oxidant; a fuel supplier for supplying the fuel to the reforming reaction part; and an oxidant supplier for supplying the oxidant to the carbon monoxide reducing part and the electricity generating element, respectively. The carbon monoxide reducing part includes the carbon monoxide oxidizing catalyst.

### BRIEF DESCRIPTION OF THE DRAWINGS

A more complete appreciation of the present invention, and many of the above and other features and advantages of the present invention, will be readily apparent as the same becomes better understood by reference to the following detailed description when considered in conjunction with the accompanying drawings in which like reference symbols indicate the same or similar components, wherein:

FIG. 1 is a schematic diagram showing the structure of a fuel cell system according to an embodiment of the present invention; and

FIG. 2 shows a conversion rate of carbon monoxide and selectivity of carbon monoxide oxidation when the temperature of the outlet of the carbon monoxide reducing part including the carbon monoxide oxidizing catalysts according to Examples 1 to 3 is 200° C.

### DETAILED DESCRIPTION OF THE EMBODIMENTS

An exemplary embodiment of the present invention will hereinafter be described in detail with reference to the accompanying drawings.

According to one embodiment of the present invention, a carbon monoxide oxidizing catalyst for a reformer of a fuel cell system is provided. In general, a fuel cell system includes an electricity generating element and a fuel supplier. A polymer electrolyte fuel cell system includes a reformer adopted to reform a fuel to a hydrogen gas.

The reformer according to one embodiment includes a reforming reaction part that generates hydrogen gas from a fuel through a catalyst reforming reaction using heat energy, and a carbon monoxide reducing part that reduces carbon monoxide concentration in the hydrogen gas through an oxidizing reaction of hydrogen gas with the oxidant.

In the carbon monoxide reducing part, preferential oxidation (PROX) of carbon monoxide occurs. Through the preferential oxidation, the carbon monoxide content included as impurities is reduced to a ppm level. It is necessary to reduce the carbon monoxide content since it poisons fuel cell catalysts, thereby deteriorating electrode performance.

Platinum-grouped metals such as Pt, Rh, Ru, and so on that are supported on alumina are used for a conventional preferential oxidation process. However, these metals have a high cost and low selectivity at a high temperature. Therefore, a novel catalyst has been needed.

The carbon monoxide oxidizing catalyst for a reformer of a fuel cell system according to one embodiment of the present invention includes an active material including an Au—Ag alloy nano-particle, and a carrier supporting the active material.

According to one embodiment, the Au—Ag alloy nano-particle has an average diameter of 0.5 to 10 nm. According to another embodiment, the Au—Ag alloy nano-particle has an average diameter of 0.5 to 2 nm. According to yet another embodiment, the Au—Ag alloy nano-particle has an average diameter of 0.9 to 1.1 nm. When the diameter of the Au—Ag alloy nano-particle is less than 0.5 nm, the Au—Ag alloy nano-particle cannot make a carbon monoxide oxidizing catalyst having an appropriate size. On the contrary, when it is greater than 10 nm, an appropriate bulk-type carbon monoxide oxidizing catalyst cannot be obtained.

The Au—Ag alloy nano-particle may include at least one element selected from the group consisting of K, Ca, and combinations thereof. The K and Ca may increase the preferential oxidation activity of the Au—Ag alloy nano-particle.

A Au atomic ratio relative to Ag of the Au—Ag alloy nano-particle may range from 0.5 to 2. According to one embodiment, the atomic ratio may range from 0.9 to 1.1. When the Au atomic ratio relative to Ag is less than 0.5, the Au content is not sufficient and thereby a catalyst activity increment due to Au may be negligible. On the contrary, when the Au atomic ratio relative to Ag is greater than 2, Au may be aggregated to decrease catalyst activity.

The carrier may be selected from the group consisting of Al₂O₃, SiO₂, TiO₂, ZrO₂, MgO, and combinations thereof. According to one embodiment, Al₂O₃ may be suitable. The carrier may be mesoporous. The active material is supported on a mesoporous carrier, and thereby Au—Ag alloy nano-particles can be dispersed better, and mobility and contacting properties of reaction materials can be improved.

The carbon monoxide oxidizing catalyst according to an embodiment of the present invention can be prepared as follows.

Au and Ag precursors are added to an ionic surfactant aqueous solution to prepare a precursor solution. A reducing agent is added to the precursor solution and then a carrier is added. The resulting precursor solution is dried and the dried product is calcinated to prepare a Au—Ag alloy nano-particle carbon monoxide oxidizing catalyst supported on a carrier.

The Au and Ag precursors can be added in appropriate amounts so that the atomic ratio of Au relative to Ag of the Au—Ag alloy nano-particle may be 0.5 to 2, and the carrier can be added in an amount that depends on an amount of the Au—Ag alloy nano-particle.

Examples of the Au precursor include at least one selected from the group consisting of HAuCl₄, HAu(CN)₄, hydrates thereof, and combinations thereof. Examples of the Ag precursor include at least one selected from the group consisting of Ag(NO)₃, Ag(CH₃COO), AgClO₄, and combinations thereof. The surfactant may include a hexadecyl trialkyl ammonium bromide such as hexadecyl trimethyl ammonium bromide (CH₃(CH₂)₁₅N(Br)(CH₃)₃). The alkyl may be a C1 to C11 alkyl. The reducing agent may include at least one selected from the group consisting of NaBH₄, KBH₄, RbBH₄, CsBH₄, and combinations thereof.

The calcinating process is performed at 500 to 600° C. for 1 to 5 hours. When the calcinating temperature is less than 500° C., calcination is not complete, while when it is greater than 600° C., the porous structure of the carbon monoxide oxidizing catalyst may be damaged. In addition, when the calcinating is performed for less than 1 hour, calcinating is not complete, while when it is performed for more than 5 hours, there may be a loss hours and an unnecessary increase in cost since calcinating is already complete.

A fuel cell system according to another embodiment of the present invention includes a reformer including a reforming reaction part that generates hydrogen gas from a fuel through a catalyst reforming reaction using heat energy, and a carbon monoxide reducing part that reduces carbon monoxide concentration in the hydrogen gas through a oxidizing reaction of carbon monoxide with oxidant; at least one electricity generating element for generating electrical energy by electrochemical reactions of the hydrogen gas and oxidant; a fuel supplier for supplying the fuel to the reforming reaction part; and an oxidant supplier for supplying an oxidant to the carbon monoxide reducing part and the electricity generating element, respectively. The carbon monoxide reducing part includes the carbon monoxide oxidizing catalyst.

Hereinafter, embodiments of the present invention will be described in detail such that they can be easily implemented by those skilled in the art of the present invention. However, the present invention may be realized in diverse forms and it is not limited to the embodiments described herein.

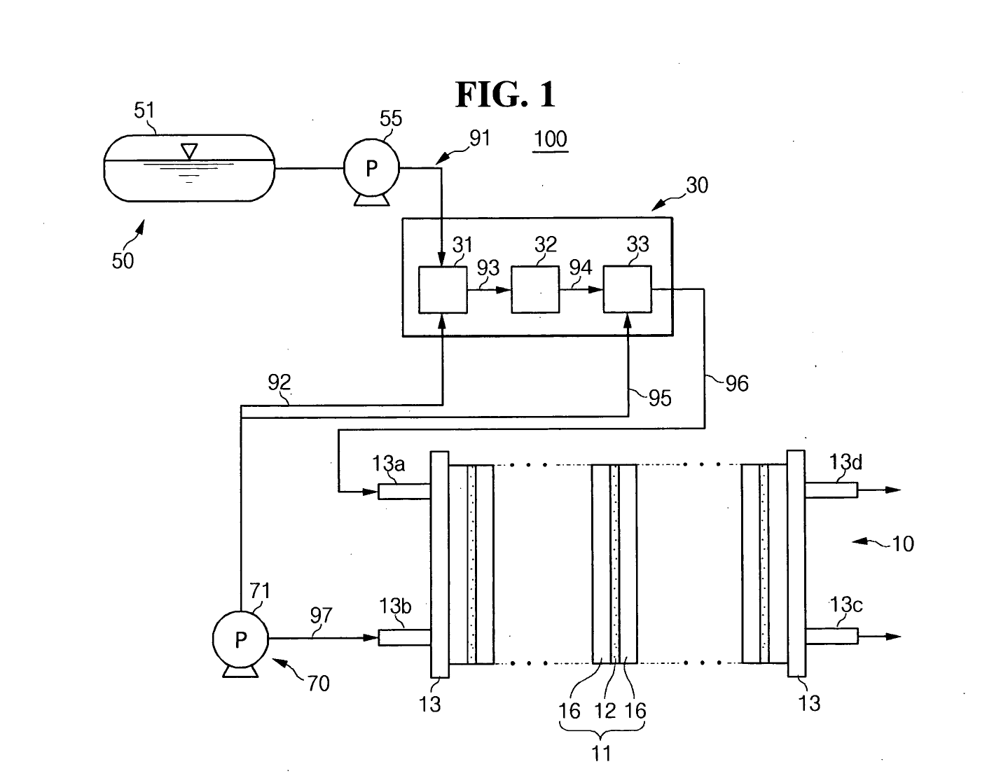

Hereinafter, a fuel cell system will be described referring to FIG. 1.

As shown in FIG. 1, the fuel cell system 100 includes: a stack 10 including an electricity generating element 11 that generates electrical energy through electrochemical reactions; a reformer 30 that generates hydrogen gas from a liquid fuel and supplies the hydrogen gas; a fuel supplier 50 for supplying a fuel to the reformer 30; and an oxidant supplier 70 for supplying an oxidant to the reformer 30 and the electricity generating element 11, respectively.

The electricity generating element 11 is formed as a minimum unit for generating electricity by disposing a membrane-electrode assembly (MEA) 12 between two separators 16, and then a stack 10 is formed with a stacked structure by arranging a plurality of minimum units. The membrane-electrode assembly 12 includes an anode and a cathode and performs hydrogen gas oxidation and oxidant reduction reactions. The separators 16 have gas passage paths, through which hydrogen gas and the oxidant are supplied, formed at both sides of the membrane-electrode assembly 12, and also function as conductors connecting the anode and the cathode in series.

The stack 10 can additionally include pressing plates 13, for positioning a plurality of the electricity generating elements 11 to be closely adjacent to each other, at the outermost ends of the stack 10. Alternatively, separators 16 at the outermost ends of the electricity generating elements 11 can be arranged to play a role of pressing the electricity generating elements 11 instead of using the separate pressing plates 13. Alternatively, the pressing plates 13 can be formed to intrinsically function as the separators 16 in addition to closely arranging the plurality of electricity generating elements 11.

The pressing plates 13 include a first inlet 13a to supply hydrogen gas to the electricity generating elements 11, a second inlet 13b to supply the oxidant to the electricity generating elements 11 from the oxidant supplier 70, a first outlet 13c to release hydrogen gas remaining after a reaction at the anodes of the membrane-electrode assemblies 12, and a second outlet 13d to release non-reacted oxidant (e.g., air) including moisture generated through a reduction reaction of the oxidant at the cathodes of the membrane-electrode assemblies 12. The oxidant may be air. When the oxidant is air, the air may be supplied through the oxidant supplier 70.

The reformer 30 has a structure for generating hydrogen gas from a fuel by chemical catalytic reactions using heat energy and for reducing the carbon monoxide concentration in the hydrogen gas.

The reformer 30 includes a heating source 31 for commonly generating heat energy through a catalytic oxidizing reaction of the fuel and the oxidant, a reforming reaction part 32 generating hydrogen gas from the fuel through a steam reforming (SR) catalyst reaction by the heat energy, and a carbon monoxide reducing part 33 for reducing the concentration of carbon monoxide included in the hydrogen gas.

In the embodiment of the present invention, the reaction of the reformer 30 is not limited to the steam reforming catalyst reaction, and may include an auto-thermal reforming (ATR) reaction and/or partial oxidation (POX) without the use of the heating source 31.

The heating source 31 is connected to a fuel tank 51 through a first supply line 91 having a pipe shape and to an oxidant pump 71 through a second supply line 92 having a pipe shape. The liquid fuel and oxidant pass through the heating source 31. The heating source 31 includes a catalyst layer (not shown) that accelerates the oxidizing reaction of the fuel with the oxidant to generate the heat energy. Herein, the heating source 31 is formed as a plate that provides a channel (not shown) capable of inflowing the liquid fuel and the oxidant. The surface of the channel is coated with the catalyst layer. The heating source 31 is preferably shaped as a cylinder that has a predetermined internal space. The internal space may be filled with a catalyst layer such as a pellet-type catalyst module or a honeycomb-type catalyst module.

The reforming reaction part 32 absorbs the heat energy generated from the heating source 31 to generate the hydrogen gas from the fuel through the steam-reforming catalyst reaction of the fuel supplied from the fuel tank 51. The reforming reaction part 32 is preferably directly connected to the heating source 31 via a third supply line 93. In addition, the reforming reaction part 32 includes a catalyst layer (not shown) for generating the hydrogen gas by accelerating the steam reforming reaction of the fuel.

The carbon monoxide reducing part 33 reduces carbon monoxide concentration in the hydrogen gas through a preferential CO oxidation catalyst reaction of the hydrogen gas with air. The hydrogen gas is generated from the reformer reaction part 32 and the air is supplied from the oxidant pump 71. The carbon monoxide reducing part 33 is connected to the reformer reaction part 32 via a fourth supply line 94, and to the oxidant pump 71 via a fifth supply line 95. Thus, the hydrogen gas and the oxidant pass through the carbon monoxide reducing part 33.

The carbon monoxide reducing part 33 is coated with a catalyst layer (not shown) including the carbon monoxide oxidizing catalyst that promotes a preferential oxidation reaction between the hydrogen gas and an oxidant and thereby reduces carbon monoxide concentration in the hydrogen gas. Herein, the carbon monoxide reducing part 33 includes a plate-shaped channel (not shown) capable of inflowing the hydrogen gas and oxidant. The surface of the channel is coated with the catalyst layer. The carbon monoxide reducing part 33 is preferably shaped as a cylinder that has a predetermined internal space. The internal space may be filled with a catalyst layer such as a pellet-type catalyst module or a honeycomb-type catalyst module.

Herein, the carbon monoxide reduction part 33 is connected to the first inlet 13a of the stack 10 via a sixth supply line 96. The carbon monoxide reduction part 33 provides the electricity generating elements 11 of the stack 10 with the hydrogen gas in which the carbon monoxide concentration is reduced through the carbon monoxide reduction part 33. In addition, the carbon monoxide reduction part 33 may include thermal conductive stainless steel, aluminum, copper, iron, and so on.

In the fuel cell system, the electricity generating element includes a membrane-electrode assembly. The membrane-electrode assembly includes a cathode and an anode facing each other, and a polymer electrolyte membrane disposed therebetween.

The cathode and the anode are each composed of an electrode substrate and a catalyst layer.

The catalyst layer of the membrane-electrode assembly may include at least one catalyst selected from the group consisting of platinum, ruthenium, osmium, platinum-ruthenium alloys, platinum-osmium alloys, platinum-palladium alloys, platinum-M alloys (where M is a transition element selected from the group consisting of Ga, Ti, V, Cr, Mn, Fe, Co, Ni, Cu, Zn, Sn, Mo, W, Rh, Ru, and combinations thereof), and combinations thereof. Examples of the catalyst includes at least one selected from the group consisting of Pt, Pt/Ru, Pt/W, Pt/Ni, Pt/Sn, Pt/Mo, Pt/Pd, Pt/Fe, Pt/Cr, Pt/Co, Pt/Ru/W, Pt/Ru/Mo, Pt/Ru/V, Pt/Fe/Co, Pt/Ru/Rh/Ni, Pt/Ru/Sn/W, and combinations thereof.

Such a catalyst may be used in a form of a metal itself (black catalyst), or one supported on a carrier. The carrier may include carbon-based material such as graphite, denka black, ketjen black, acetylene black, carbon nanotubes, carbon nano fiber, carbon nano wire, carbon nanoballs, or activated carbon, or an inorganic particulate such as alumina, silica, zirconia, or titania. A carbon-based material is generally used.

The catalyst layer of the anode and the cathode may further include a binder resin having ion conductivity to improve adherence to the polymer electrolyte membrane and the proton transferring property.

The binder resin may be a proton conductive polymer resin having a cation exchange group selected from the group consisting of a sulfonic acid group, a carboxylic acid group, a phosphoric acid group, a phosphonic acid group, and derivatives thereof at its side chain. Non-limiting examples of the binder resin include at least one proton conductive polymers selected from the group consisting of perfluoro-based polymers, benzimidazole-based polymers, polyimide-based polymers, polyetherimide-based polymers, polyphenylenesulfide-based polymers polysulfone-based polymers, polyethersulfone-based polymers, polyetherketone-based polymers, polyether-etherketone-based polymers, and polyphenylquinoxaline-based polymers. In one embodiment, the proton conductive polymer is at least one selected from the group consisting of poly(perfluorosulfonic acid), poly(perfluorocarboxylic acid), a copolymer of tetrafluoroethylene and fluorovinylether having a sulfonic acid group, defluorinated polyetherketone sulfide, aryl ketone, poly(2,2′-(m-phenylene)-5,5′-bibenzimidazole), or poly (2,5-benzimidazole).

The binder resin may be used singularly or as a mixture. Optionally, the binder resin may be used along with a non-conductive polymer to improve adherence between a polymer electrolyte membrane and the catalyst layer. The use amount of the binder resin may be adjusted to its usage purpose.

Non-limiting examples of the non-conductive polymer include polytetrafluoroethylene (PTFE), tetrafluoroethylene-hexafluoropropylene copolymers (FEP), tetrafluoroethylene-perfluoro alkyl vinylether copolymers (PFA), ethylene/tetrafluoroethylene (ETFE)), ethylenechlorotrifluoro-ethylene copolymers (ECTFE), polyvinylidene fluoride, polyvinylidene fluoride-hexafluoropropylene copolymers (PVdF-HFP), dodecyl benzene sulfonic acid, sorbitol, and combinations thereof.

The electrode substrates of the anode and the cathode provide a path for transferring the fuel and the oxidant to catalyst layers. In one embodiment, the electrode substrates are formed from a material such as carbon paper, carbon cloth, carbon felt, or a metal cloth (a porous film composed of a metal fiber or a metal film disposed on a surface of a cloth composed of polymer fibers). The electrode substrate is not limited thereto.

The electrode substrates may be treated with a fluorine-based resin to be water-repellent to prevent deterioration of diffusion efficiency due to water generated during operation of the fuel cell. The fluorine-based resin may include polytetrafluoroethylene, polyvinylidene fluoride, polyhexafluoropropylene, polyperfluoroalkylvinylether, polyperfluorosulfonylfluoride alkoxyvinyl ether, fluorinated ethylene propylene, polychlorotrifluoroethylene, or copolymers thereof, but is not limited thereto.

A microporous layer can be added between the aforementioned electrode substrates and the catalyst layers to increase reactant diffusion effects. The microporous layer generally includes conductive powders with a particular particle diameter. The conductive material may include, but is not limited to, carbon powder, carbon black, acetylene black, activated carbon, carbon fiber, fullerene, nano-carbon, or combinations thereof. The nano-carbon may include a material such as carbon nanotubes, carbon nanofiber, carbon nanowire, carbon nanohorns, carbon nanorings, or combinations thereof.

The microporous layer is formed by coating a composition including a conductive powder, a binder resin, and a solvent on the conductive substrate. The binder resin may include, but is not limited to, polytetrafluoroethylene, polyvinylidenefluoride, polyhexafluoropropylene, polyperfluoroan alkylvinylether, polyperfluorosulfonylfluoride, alkoxyvinyl ether, polyvinylalcohol, cellulose acetate, or copolymers thereof. The solvent may include, but is not limited to, an alcohol such as ethanol, isopropyl alcohol, n-propyl alcohol, butanol, and so on, water, dimethylacetamide, dimethylsulfoxide, N-methylpyrrolidone, tetrahydrofuran, and so on. The coating method may include, but is not limited to, screen printing, spray coating, doctor blade methods, gravure coating, dip coating, silk screening, painting, and so on, depending on the viscosity of the composition.

The polymer electrolyte membrane may include an excellent proton conductive polymer that functions as an ion exchanger by delivering a proton produced at the catalyst layer of the anode to the catalyst layer of the cathode.

Examples of the proton conductive polymer may include any polymer resin having a cation exchange group selected from the group consisting of a sulfonic acid group, a carboxylic acid group, a phosphoric acid group, a phosphonic acid group, and derivatives thereof, at its side chain.

Non-limiting examples of the polymer resin may be at least one selected from the group consisting of fluoro-based polymers, benzimidazole-based polymers, polyimide-based polymers, polyetherimide-based polymers, polyphenylenesulfide-based polymers polysulfone-based polymers, polyethersulfone-based polymers, polyetherketone-based polymers, polyether-etherketone-based polymers, and polyphenylquinoxaline-based polymers. In one embodiment, the proton conductive polymer is at least one selected from the group consisting of poly(perfluorosulfonic acid) (NAFION™), poly(perfluorocarboxylic acid), a copolymer of tetrafluoroethylene and fluorovinylether including a sulfonic acid group, defluorinated polyetherketone sulfide, aryl ketone, poly(2,2′-(m-phenylene)-5,5′-bibenzimidazole), and poly(2,5-benzimidazole).

The H can be replaced with Na, K, Li, Cs, or tetrabutylammonium in a proton conductive group of the proton conductive polymer. When the H is replaced with Na in an ion exchange group at the terminal end of the proton conductive group, NaOH is used. When the H is replaced with tetrabutylammonium, tetrabutylammonium hydroxide is used. K, Li, or Cs can also be replaced by using appropriate compounds. A method of replacing H is known in the related art, and therefore is not described in detail.

The electrodes of the anode and the cathode may be fabricated by coating a catalyst composition including a catalyst, a binder, and a solvent on the electrode substrates by using a general coating method such as spray coating, doctor blade coating, and so on. The electrode fabrication process is known in the related art, and therefore is not described in detail.

The following examples illustrate the present invention in more detail. However, it is understood that the present invention is not limited by these examples.

### EXAMPLE 1

1.080 g of HAuCl₄.3H₂O and 0.233 g of Ag(NO)₃ were added to 0.1 ml of an aqueous solution that was prepared by adding 3 g of hexadecyltrimethyl ammonium bromide to 1,000 ml of water to prepare a yellow precursor solution. 0.3632 g of NaBH₄ was added to the yellow precursor solution. Then 14.8 g of mesoporous Al₂O₃ was added to the yellow precursor solution. The precursor solution was dried and then calcinated at 550° C. for 1 hour to obtain a Au—Ag alloy nano-particle carbon monoxide oxidizing catalyst supported on mesoporous Al₂O₃. The atomic ratio of Au relative to Ag was 2.0, and the average diameter of the Au—Ag alloy nano-particle carbon monoxide oxidizing catalyst was 1 nm.

The carbon monoxide oxidizing catalyst was filled in a carbon monoxide reducing part at an amount of 10 ml. A gas including 14.38 mol % of CO₂, 39.23 mol % of H₂, 12.29 mol % of N₂, 0.33 mol % of CH₄, 0.31 mol % of CO, 0.30 mol % of O₂, and 33.16 mol % of H₂O was flowed into the carbon monoxide reducing part including the above carbon monoxide oxidizing catalyst. At the outlet of the carbon monoxide reducing part, concentrations of hydrogen gas and carbon monoxide, and a conversion rate of carbon monoxide, were measured, and the results are shown in the following Table 1.

### EXAMPLE 2

A Au—Ag alloy nano-particle carbon monoxide oxidizing catalyst supported on mesoporous Al₂O₃ was prepared according to the same method as in Example 1, except that 0.540 g of HAuCl₄.3H₂O and 0.2075 g of NaBH₄ were used. The atomic ratio of Au relative to Ag was 1.0, and the average diameter of the Au—Ag alloy nano-particle carbon monoxide oxidizing catalyst was 1.2 nm. At the outlet of the carbon monoxide reducing part including the above carbon monoxide oxidizing catalyst, concentrations of hydrogen gas and carbon monoxide, and a conversion rate of carbon monoxide, were measured according to the same method as in Example 1, and the results are shown in the following Table 2.

### EXAMPLE 3

A Au—Ag alloy nano-particle carbon monoxide oxidizing catalyst supported on mesoporous Al₂O₃ was prepared according to the same method as in Example 1, except that 0.270 g of HAuCl₄.3H₂O and 0.1297 g of NaBH₄ were used. The atomic ratio of Au relative to Ag was 0.5, and the average diameter of the Au—Ag alloy nano-particle carbon monoxide oxidizing catalyst was 2.0 nm. At the outlet of the carbon monoxide reducing part including the above carbon monoxide oxidizing catalyst, concentrations of hydrogen gas and carbon monoxide, and a conversion rate of carbon monoxide, were measured according to the same method as in Example 1, and the results are shown in the following Table 3.

### COMPARATIVE EXAMPLE 1

A 1M Na₂CO₃ solution was added to a solution including HAuCl₄ hydrate and Ce(NO₃)₃.6H₂O. The resulting solution was allowed to stand at a normal temperature for 1 hour while maintaining pH 8.0. Then the solution was repeatedly washed with distilled water until excessive anions disappeared. After washing, the solution was dried at 656.15° C. for 24 hours, and the dried product was calcinated at 1046.15° C. for 5 hours to prepare a powder-shaped AuCeO₂ catalyst that was unsupported and included 1 wt % of Au.

The AuCeO₂ catalyst was filled in a carbon monoxide reducing part at an amount of 10 ml. A gas including 20 mol % of CO₂, 40 mol % of H₂, 1 mol % of CO, and 1 mol % of O₂ was flowed into the carbon monoxide reducing part at a space velocity of 30,000 h⁻¹. At the outlet of the carbon monoxide reducing part, a conversion rate of carbon monoxide depending on temperature was measured. At the carbon monoxide reducing part, the maximal conversion rate of carbon monoxide was 82% at 170° C.

### COMPARATIVE EXAMPLE 2

AgNO₃ and Co(NO₃)₂.6H₂O were added to distilled water to prepare a silver-cobalt solution. The total metal concentration in the silver-cobalt solution was 0.1M. The silver-cobalt solution was added to a 1M Na₂CO₃ solution to prepare a silver-cobalt solution with pH 8.0. The silver-cobalt solution was impregnated for 3 hours, filtered, and repeatedly washed to remove excessive ions. The silver-cobalt solution was dried at 110° C. for 24 hours under air, and calcinated at 200° C. to 500+ C. for 3 hours to prepare a AgCoO₂ catalyst including 1 wt % of Ag.

The AgCeO₂ catalyst was filled in a carbon monoxide reducing part at an amount of 10 ml. A gas including 20 mol % of CO₂, 40 mol % of H₂, 1 mol % of CO, and 1 mol % of O₂ was flowed into the carbon monoxide reducing part at a space velocity of 30,000 h⁻¹. At the outlet of the carbon monoxide reducing part, a conversion rate of carbon monoxide depending on temperature was measured. At the carbon monoxide reducing part, the maximal conversion rate of carbon monoxide was 30% at 180° C.

TABLE 1
Carbon monoxide oxidizing catalyst of Example 1

Temperature (° C.)

| | 150 | 175 | 200 | 220 |
|---|---|---|---|---|
| CO oxidation | 65.32 | 61.02 | 59.2 | 39.68 |
| selectivity (%) | | | | |
| CO conversion | 37.45 | 37.1 | 89 | 77.88 |
| rate (%) | | | | |
| Released CO | 3013 | 2901 | 507 | 1019 |
| concentration | | | | |
| (ppm) | | | | |
| Released H₂ | 479 | 479 | 478 | 476 |
| amount (ml/min) | | | | |

TABLE 2
Carbon monoxide oxidizing catalyst of Example 2

Temperature (° C.)

| | 150 | 175 | 200 | 220 |
|---|---|---|---|---|
| CO oxidation | 76.4 | 68.24 | 60.15 | 39.24 |
| selectivity (%) | | | | |
| CO conversion | 35.73 | 38.94 | 89.42 | 78.16 |
| rate (%) | | | | |
| Released CO | 2961 | 2812 | 488 | 1006 |
| concentration | | | | |
| (ppm) | | | | |
| Released H₂ | 480 | 479 | 478 | 475 |
| amount (ml/min) | | | | |

TABLE 3
Carbon monoxide oxidizing catalyst of Example 3

Temperature (° C.)

| | 150 | 175 | 200 | 220 |
|---|---|---|---|---|
| CO oxidation | 58.04 | 55.22 | 39.88 | 20.36 |
| selectivity (%) | | | | |
| CO conversion | 10.82 | 13.32 | 78.36 | 40.56 |
| rate (%) | | | | |
| Released CO | 4108 | 3993 | 997 | 2738 |
| concentration | | | | |
| (ppm) | | | | |
| Released H₂ | 480 | 480 | 476 | 474 |
| amount (ml/min) | | | | |

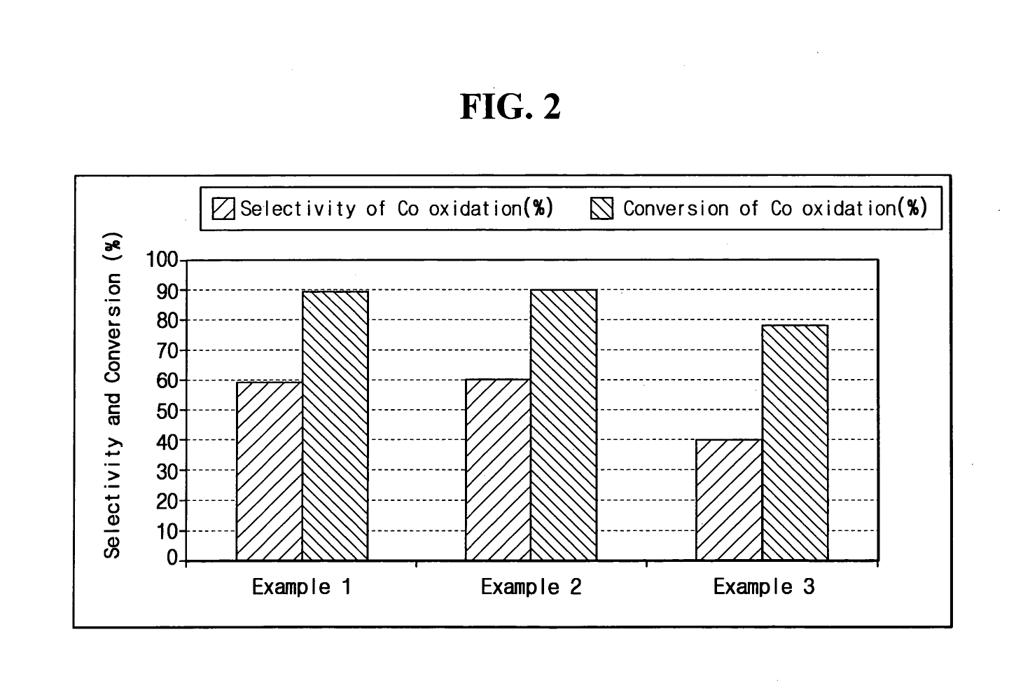

Referring the Tables 1 to 3, the carbon monoxide conversion rate was highest at 200° C. At the outlet of the carbon monoxide reducing part including the carbon monoxide oxidizing catalyst according to Examples 1 to 3 and Comparative Examples 1 and 2, the temperature at which the carbon monoxide conversion rate was highest and the maximal carbon monoxide conversion rate were as provided in the following Table 4. When the temperature at the outlet of the carbon monoxide reducing part including the carbon monoxide oxidizing catalyst according to Examples 1 to 3 is 200° C., the carbon monoxide conversion rate is as shown in FIG. 2.

TABLE 4

| | Exam- | Exam- | Exam- | Comparative | Comparative |
|---|---|---|---|---|---|
| | ple 1 | ple 2 | ple 3 | Example 1 | Example 2 |
| Temperature at | 200 | 200 | 200 | 170 | 180 |
| outlet (° C.) | | | | | |
| CO oxidation | 59.2 | 60.15 | 39.88 | — | — |
| selectivity (%) | | | | | |
| CO conversion | 89 | 89.42 | 78.36 | 82 | 30 |

As shown in Table 4 and FIG. 2, when the temperature at the outlet of the carbon monoxide reducing part of Comparative Example 1 was 170° C., the carbon monoxide conversion rate was 82%. When the temperature at the outlet of the carbon monoxide reducing part of Comparative Example 2 was 180° C., the carbon monoxide conversion rate was 30%. On the contrary, in case of Examples 1 to 3, the carbon monoxide conversion rate was over 78% at a high temperature of 200° C. In particular, in the case of Examples 1 and 2, the carbon monoxide conversion rate was high at over 89%.

The Au—Ag alloy carbon monoxide oxidizing catalyst for a reformer of a fuel cell system can show much better reactivity with carbon monoxide than a Au-based catalyst and a Ag-based catalyst. The reaction area is increased by preparing the Au—Ag alloy in a nano-particle size, and supporting the Au—Ag alloy on a mesoporous carrier to provide a carbon monoxide oxidizing catalyst having carbon monoxide oxidation reaction activity and selectivity at a high temperature.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A carbon monoxide oxidizing catalyst for a reformer of a fuel cell system, comprising:
an active material including Au—Ag alloy nano-particles; and
a carrier supporting the active material.

2. The carbon monoxide oxidizing catalyst of claim 1, wherein the Au—Ag alloy nano-particles have an average diameter of 0.5 to 10 nm.

3. The carbon monoxide oxidizing catalyst of claim 2, wherein the Au—Ag alloy nano-particles have an average diameter of 0.5 to 2 nm.

4. The carbon monoxide oxidizing catalyst of claim 3, wherein the Au—Ag alloy nano-particles have an average diameter of 0.9 to 1.1 nm.

5. The carbon monoxide oxidizing catalyst of claim 1, wherein each Au—Ag alloy nano-particle further comprises at least one element selected from the group consisting of K, Ca, and combinations thereof.

6. The carbon monoxide oxidizing catalyst of claim 1, wherein an Au atomic ratio relative to Ag of the Au—Ag alloy nano-particles ranges from 0.5 to 2.

7. The carbon monoxide oxidizing catalyst of claim 1, wherein the Au atomic ratio relative to Ag of the Au—Ag alloy nano-particles ranges from 0.9 to 1.1.

8. The carbon monoxide oxidizing catalyst of claim 1, wherein the carrier is selected from the group consisting of Al₂O₃, SiO₂, TiO₂, ZrO₂, MgO, and combinations thereof.

9. The carbon monoxide oxidizing catalyst of claim 1, wherein the carrier is a mesoporous carrier.

10. The carbon monoxide oxidizing catalyst of claim 1, wherein the carrier is mesoporous Al₂O₃.

11. The carbon monoxide oxidizing catalyst of claim 1, wherein the carrier is mesoporous Al₂O₃, and a Au atomic ratio relative to Ag of the Au—Ag alloy nano-particles ranges from 0.5 to 2.

12. A reformer for fuel cell system, comprising:
a reforming reaction part generating hydrogen gas from a fuel; and
a carbon monoxide reducing part reducing a carbon monoxide concentration in the hydrogen gas through an oxidizing reaction of carbon monoxide with an oxidant, the carbon monoxide reducing part comprising the carbon monoxide oxidizing catalyst of claim 1.

13. A fuel cell system comprising the reformer of claim 12, and at least one electricity generating element for generating electrical energy by electrochemical reactions of the hydrogen gas and the oxidant.

14. A method of preparing a carbon monoxide oxidizing catalyst for a reformer of a fuel cell system, comprising:
preparing a precursor solution by adding Au and Ag precursors to an ionic surfactant aqueous solution;
adding a reducing agent to the precursor solution;
adding a carrier to the precursor solution;
drying the precursor solution to obtain a dried product; and
calcinating the dried product to prepare the carbon monoxide oxidizing catalyst comprising an active material including Au—Ag alloy nano-particles and the carrier supporting the active material.

15. The method of claim 14, wherein the Au and Ag precursors are added to obtain the atomic ratio of Au relative to Ag of the Au—Ag alloy nano-particles ranging from 0.5 to 2.

16. The method of claim 14, wherein the Au precursor is selected from the group consisting of HAuCl₄, HAu(CN)₄, hydrates thereof, and combinations thereof.

17. The method of claim 14, wherein the Ag precursor is selected from the group consisting of Ag(NO)₃, Ag(CH₃COO), AgClO₄, and combinations thereof.

18. The method of claim 14, wherein the ionic surfactant is hexadecyl trimethyl ammonium bromide, and the reducing agent is selected from the group consisting of NaBH₄, KBH₄, RbBH₄, CsBH₄, and combinations thereof.

19. The method of claim 14, wherein the carrier is selected from the group consisting of Al₂O₃, SiO₂, TiO₂, ZrO₂, MgO, and combinations thereof.

20. The method of claim 14, wherein the carrier is a mesoporous carrier.

21. The method of claim 14, wherein the carrier is mesoporous Al₂O₃.

22. The method of claim 14, wherein the calcinating is performed at 500 to 600° C. for 1 to 5 hours.

23. The carbon monoxide oxidizing catalyst prepared by the method of claim 12.

24. A fuel cell system, comprising:
a reformer comprising:
a reforming reaction part generating hydrogen gas from a fuel through a catalyst reforming reaction using heat energy; and
a carbon monoxide reducing part reducing a carbon monoxide concentration in the hydrogen gas through an oxidizing reaction of carbon monoxide with an oxidant, the carbon monoxide reducing part comprising a carbon monoxide oxidizing catalyst, the carbon monoxide oxidizing catalyst comprising an active material including Au—Ag alloy nano-particles and a carrier supporting the active material;
at least one electricity generating element for generating electrical energy by electrochemical reactions of the hydrogen gas and the oxidant;
a fuel supplier for supplying the fuel to the reforming reaction part; and
an oxidant supplier for supplying the oxidant to the carbon monoxide reducing part and the electricity generating element, respectively.

25. The fuel cell system of claim 24, wherein the Au—Ag alloy nano-particles have an average diameter of 0.5 to 10 nm.

26. The fuel cell system of claim 24, wherein the Au—Ag alloy nano-particles further comprise at least one element selected from the group consisting of K, Ca, and combinations thereof.

27. The fuel cell system of claim 24, wherein a Au atomic ratio relative to Ag of the Au—Ag alloy nano-particles ranges from 0.5 to 2.

28. The fuel cell system of claim 24, wherein the carrier is a mesoporous carrier.

29. The fuel cell system of claim 24, wherein the carrier is selected from the group consisting of Al₂O₃, SiO₂, TiO₂, ZrO₂, MgO, and combinations thereof.

30. The fuel cell system of claim 24, wherein the carrier is mesoporous Al₂O₃, and a Au atomic ratio relative to Ag of the Au—Ag alloy nano-particles ranges from0.5 to 2.
